(19) United States
(12) Patent Application Publication
(10) Pub. No.: US 2002/0154839 A1
(43) Pub. Date: Oct. 24, 2002

(54) Kinematic stage assembly

(75) Inventor: David Trost, San Francisco, CA (US)

Correspondence Address: APPLIED MATERIALS, INC., 2881 SCOTT BLVD. M/S 2061, SANTA CLARA, CA, 95050, US

(73) Assignee: Applied Materials, Inc, Santa Clara, CA

(21) Appl. No.: 09/860,205

(22) Filed: May 18, 2001

Related U.S. Application Data
(62) Division of application No. 09/838,126, filed on Apr. 20, 2001.

(51) Int. Cl. F16C 32/06

(52) U.S. Cl. 384/100

(57) ABSTRACT

Disclosed is a stage system including a journal having a longitudinal axis; a body defining a chamber having chamber wall, with the journal passing through the chamber, the body having a fluid inlet and a plurality of fluid outlets flanking the fluid inlet, with the fluid inlet and the plurality of fluid outlets being in fluid communication with the chamber; a fluid supply system to introduce a supply fluid into the chamber through the fluid inlet and evacuate the supply fluid through the plurality of outlets so as to maintain a cushion of fluid between the chamber wall and the journal.

### CROSS-REFERENCE TO RELATED PATENT APPLICATIONS

The present patent application is a divisional patent application of U.S. patent application entitled METHOD AND SYSTEM TO ACHIEVE THERMAL TRANSFER BETWEEN A WORKPIECE AND A HEATED BODY DISPOSED IN A CHAMBER having David Trost and Francis C. Chilese, which was filed on Apr. 20, 2001 and identified as attorney docket number 5524/ESI-00-12 and is incorporated by reference in its entirety.

### BACKGROUND OF THE INVENTION

The present invention relates to photo mask production. More specifically, the invention relates to stage to support a plate upon which a pattern is recorded to produce photo masks.

Stages to support workpieces undergoing processing typically provide for movement along at least two directions, referred to as X-Y stages. One application of X-Y stages is in electron beam lithography systems. Electron beam lithography systems employ a charged particle beam to create a mask by drawing an integrated circuit pattern on a photosensitive resin disposed on a plate typically made of clear glass or quartz that is covered with a metallic compound, such as chrome. The stage supports the plate and displaces the same with respect to the charged particle beam to record an integrated circuit pattern on the plate. The pattern is recorded on the plate as regions that are either transparent or opaque to light. The integrated circuit pattern is transferred to a semiconductor wafer/substrate using well know photolithography techniques.

The nature of the electron beam photolithography requires precise control of the relative position between the plate and the charged particle beam to provide high-resolution recording of patterns. As a result, mechanical and thermal disturbances in the electron beam lithographic system may degrade the resolution of the system by, inter alia, degrading the positioning accuracy provided by the stage.

What is needed, therefore, is an improved stage for electron photolithography systems.

### SUMMARY OF THE INVENTION

An embodiment of the present invention provides advantages to satisfy the aforementioned need with a stage system including a journal having a longitudinal axis; a body defining a chamber having chamber wall, with the journal passing through the chamber, the body having a fluid inlet and a plurality of fluid outlets flanking the fluid inlet, with the fluid inlet and the plurality of fluid outlets being in fluid communication with the chamber; a fluid supply system to introduce a supply fluid into the chamber through the fluid inlet and evacuate the supply fluid through the plurality of outlets so as to maintain a cushion of fluid between the chamber wall and the journal. Another embodiment of the present invention is direction to a method for reducing friction between the chamber and the chamber wall.

### BRIEF DESCRIPTION OF THE DRAWINGS

FIG. 1 is a simplified plan view of an electron beam system in accordance with the present invention;

FIG. 2 is a perspective view of the electron beam system shown in FIG. 1;

FIG. 3 is a detailed perspective view of an automatic material handling system employed in the electron beam system shown in FIGS. 1 and 2;

FIG. 4 is a detailed perspective view of a pallet that is included in the system shown in FIGS. 1 and 2;

FIG. 5 is a detailed cross-sectional view of the pallet shown in FIG. 4, taken along lines 5-5;

FIG. 6 is a detailed perspective view of an airlock and robotic subsystems included in the automatic material handling system shown in FIG. 3;

FIG. 7 is a cross-sectional view of the airlock assembly shown in FIG. 6, taken along lines 7-7;

FIG. 8 is a detailed perspective view of a rapid thermal conditioning system included in the airlock shown in FIGS. 6 and 7;

FIG. 9 is a flow diagram showing a method of achieving equilibrium between a plate and a writing chamber employing the rapid thermal conditioning system shown above in FIG. 8;

FIG. 10 is an exploded perspective view of a worktable upon shown above in FIG. 2;

FIG. 11 is a top down plan view of a stage shown above in FIG. 2;

FIG. 12 is a perspective view of a stage shown above in FIG. 2;

FIG. 13 is a cross-sectional view of a journal and bearing housing shown above in FIG. 11 and taken along lines 13-13; and

FIG. 14 is a cross-sectional plan view of a write chamber shown above in FIG. 1.

### DESCRIPTION OF THE SPECIFIC EMBODIMENTS

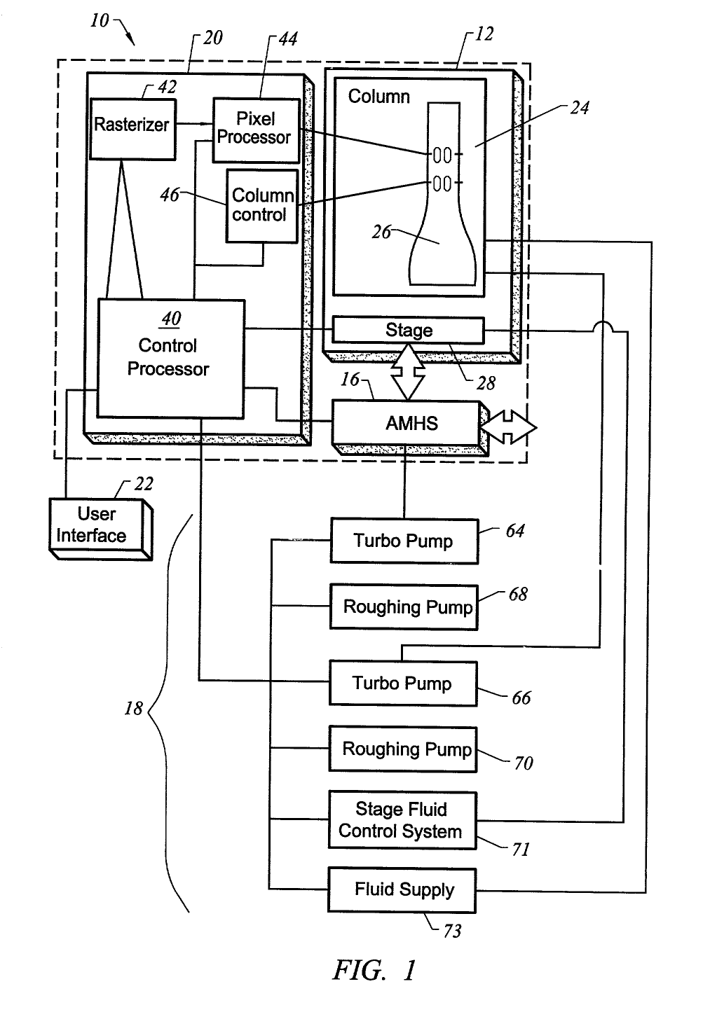

Referring to FIG. 1, a simplified plan view of an electron beam system 10 in accordance with the present invention includes a writing module 12, an automatic material handling system (AMHS) 16, a fluid control system 18, a process control system 20 and a user interface 22. Operation of electron beam system 10 is controlled by an operator accessing process control system 20 to record an image upon a plate (not shown) of glass or quartz that is covered with chrome or some other conductive material. To that end, user interface 22 is in data communication with process control system 20. Write module 12, AMHS 16, and fluid control system 18 are in data communication with, and operate under control of, process control system 20.

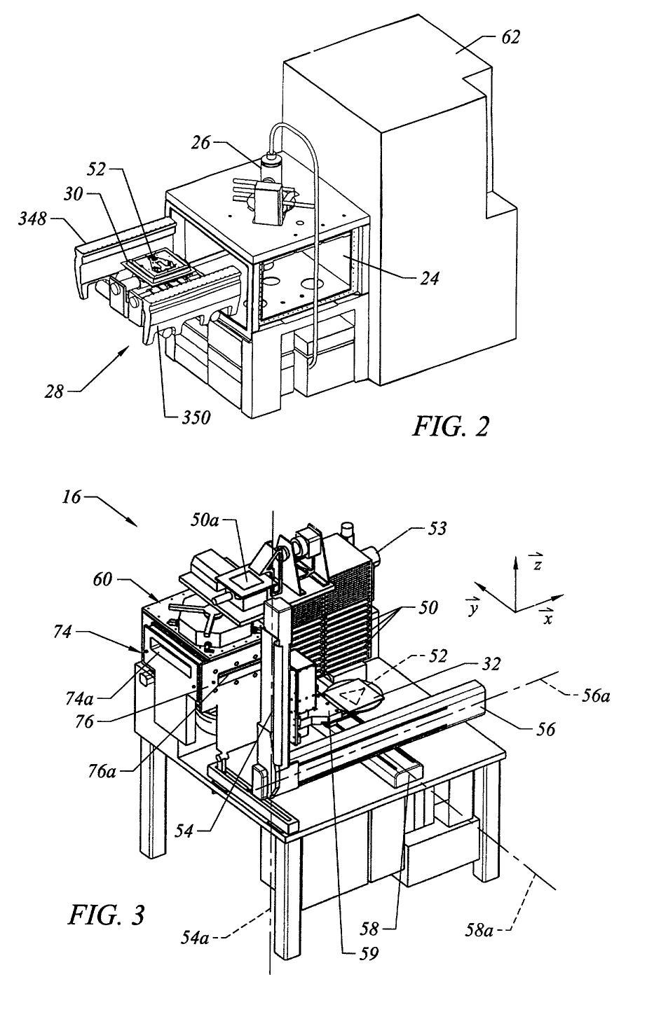

Referring to FIGS. 1 and 2, write module 12 includes a write chamber 24, an electron beam (e-beam) source 26, a fluid-bearing stage 28, and a worktable 30. Worktable 30 supports the plate (not shown) and is coupled to stage 28. Stage 28 is disposed within write chamber 24. E-beam source 26 is positioned to direct an e-beam onto plate (not shown) when positioned on worktable 30. Movement of stage 28 in x-y planes allows the entire surface of the plate (not shown) to be exposed to an e-beam (not shown) produced by e-beam source 26. In this manner, a pattern may be recorded on the plate (not shown). To that end, process control system 20 includes a control processor 40 that synchronizes the e-beam (not shown) and motion of stage 28 to ensure that the data is written in the proper location on the plate (not shown).

Also included in process control system 20 is a rasterizer 42 that transforms a user input file, typically consisting of high-level geometry primitives, into a rasterized image. Specifically, rasterizer 42 is software that transforms geometry data into phases that are sent to individual geometry engines (GEs) in the rasterizer to produce digital pixel information. Although any number of GEs may be present, in the present example, sixteen GEs are included for high-density data. The digital pixel information generated by rasterizer 42 is streamed to pixel processor 44. Pixel processor 44 converts the pixel information into dose and micro deflection waveforms to control characteristics of the e-beam produced by e-beam source 26, under control of control processor 40. Specifically, control processor 40 is in data communication with both pixel processor 44 and a column control module 46 over a common bus. Column control module 46 provides analog control signals that drive the e-beam source 26, as well as video signal collection and processing. Control processor 40 is in data communication with a sensor (not shown), such as an interferometer, to detect positional errors in stage 28. Information concerning the positional errors is used by column control module 46 to adjust e-beam (not shown) accordingly. To that end, one example of an e-beam source includes a 50 kV column that allows column control module 46 to dynamically provide linearity and focus correction to the e-beam (not shown) produced thereby. By synchronizing the pixel stream and stage/write window movement, real-time adjustments of the position of the e-beam (not shown) may be achieved.

Referring to FIGS. 1, 2 and 3, control processor 40 controls AMHS 16 to transfer plate 32 from, and to, stage 28. AMHS 16 stores the plates, one of which is shown as 32, in addressable locations, referred to as garages 50, so that plate 32 may be move between garages 50 and stage 28. Garages 50 are designed to minimize particulate cross-contamination, and have laminar airflow therethrough to facilitate thermal control. One to six pallets 52 may be stored in each of garages 50. Plate 32 may be stored in one of garages 50 resting atop of pallet 52 or may be stored in a separate garage 50 without pallet 52 being present, discussed more fully below. With this configuration, garages 50 allow plate 32 and pallet 52 to be heated to a desired temperature.

AMHS 16 includes a system of robotic mechanisms to move plate 32/pallet 52 combination to and from write chamber 24. The robotic mechanisms include a vacuum handling system 53, a vertical stage 54, a first horizontal stage 56, a second horizontal stage 58, and an end effector 59. End effector 59 is coupled to move along a longitudinal axis 54a of vertical stage 54. Vertical stage 54 is coupled to move along the longitudinal axis 56a of first horizontal stage 56, thereby facilitating movement of end effector 59 along the same axis. Horizontal stage 56 is coupled to move along a longitudinal axis 58a of second horizontal stage 58, thereby facilitating movement of first horizontal stage 56, vertical stage 54 and end effector 59 along the same axis. One manner in which to create plate 32/pallet 52 combination requires end effector 59 to obtain a pallet 52 from one of garages 50 and place pallet 52 on a pre-alignment station 50a. Thereafter, end effector 59 retrieves plate 32 from another garage and places it on pallet 52, located on pre-alignment station 50a, forming a plate 32/pallet 52 combination. This plate 32/pallet 52 combination is then transported to airlock 60.

Also included in AMHS 16 is an airlock 60 that is designed to thermally condition plate 32 before entering write chamber 24. Vacuum handling system 53 facilitates movement of plat 32/pallet 52 combination within airlock 60 and between airlock 60 and write chamber 24, discussed more fully below. Garages 50, airlock 60 and robotic mechanisms are enclosed by a housing 62 to provide clean room filtration and temperature control of an ambient enclosed by housing 62. AMHS 16 also includes a detection system (not shown), such as a barcode reader, that senses information recorded on pallet 52 that indicates characteristics of pallet 52, such as the address of the garage 50 that corresponds thereto, the size plate 32 supported thereon and the like.

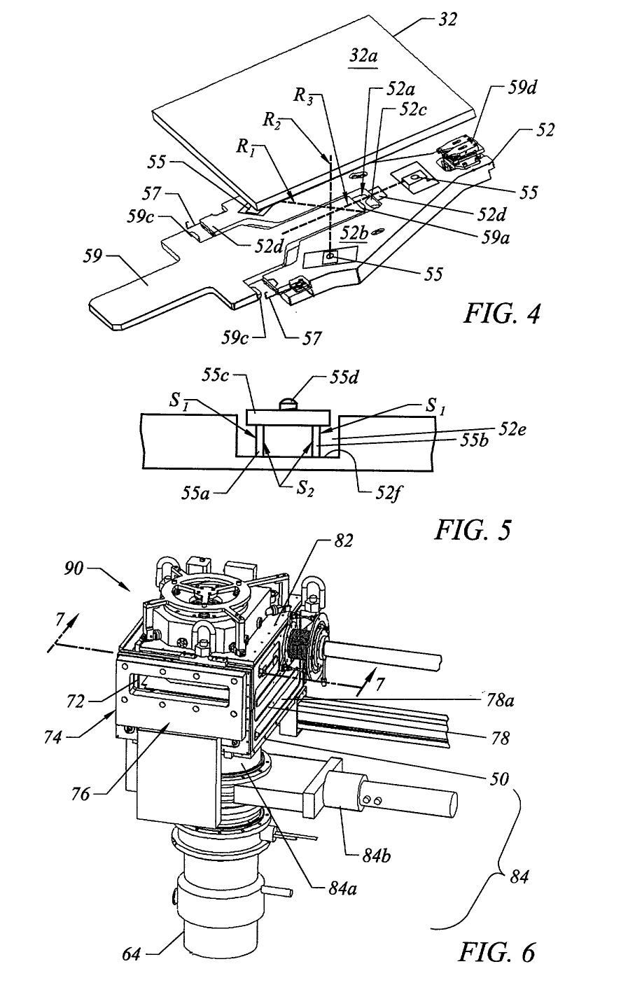

Referring to FIG. 4, pallet 52 includes a coupling groove 52a formed into major surface 52b, with a coupling tab 52c disposed at one end of coupling groove 52a. End effector 59 has a profile complementary to the profile of the coupling groove 52a and includes a projection 59a. End effector 59 includes a plurality of coupling tabs 59c, and pallet 52 includes a plurality of couplings recesses 52d. Each coupling recesses 52d is adapted to receive one of the plurality of coupling tabs 59c. Coupling and decoupling of end effector 59 and pallet 52 is achieved by having the same lie in a common plane and providing relative movement between end effector 59 and pallet 52. In a coupled position, coupling tabs 59c are disposed in recesses 52c, and coupling tab 52c rests underneath projection 59a to support the same.

Referring to FIGS. 4 and 5, to ensure unrestricted movement between pallet 52 and end effector 59, plate 32 sits atop of pallet 52 so as to be spaced-apart from surface 52b. To that end, pallet 52 includes a plurality of flexible support systems 55 coupled to a support recess 52e formed into surface 52b. Flexible support systems 55 are designed to allow a small amount of motion along one of three radial axes, R₁, R₂ and R₃, toward the center of pallet 52 while restricting, if not preventing, motion in directions transverse thereto. Each of flexible systems 55 includes two spaced apart flexures 55a and 55b that are coupled to a nadir surface 52f of support recess 52. Each of flexures 55a and 55b includes opposed major surfaces S₁, and S₂ that extend in a plane orientated transversely to one of the three radial axes, R₁, R₂ and R₃. Coupled between flexures 55a and 55b, opposite of nadir surface 52f, is a support surface 55c. An end-stone 55d extends from support surface 55c to support plate 32.

Expansion of plate 32 is facilitated to compensate for thermal changes that occur during write operations, while preventing slippage between plate 32 and end-stone 55d. To that end, plate 32 is not clamped to the pallet 52. Rather, plate 32 is gravity biased against flexible support systems 55 so that the relative position between plate 32 and flexible support systems 55 is maintained by the friction created by the weight of plate 32 against end-stone 55d. This is achieved by forming end-stone 55d from a material having a coefficient of friction in the range of 0.10 to 1.0. Thus, plate 32 does not slip if subjected to an acceleration no greater than the coefficient of friction times g, the acceleration due to gravity. In the present configuration, the material and shape from which flexible support systems 55 are fabricated are designed to achieve a hertzian contact joint that provides a resonant frequency between plate 32 and pallet 52 in excess of 200 Hertz. To that end, flexures 55a and 55b are formed from titanium, and are adhered to nadir surface 52f in any manner known in the art. As shown, three flexible support systems 55 support plate 32, which allows a predictable amount of sag in plate 32 due to gravity. The sag, just a few microns for a 230 mm plate 32, induces a small amount of lateral motion that may be corrected, because it is predictable. To reduce thermal drift, pallet 52 is typically formed from a ceramic material, such as ZERODUR®. ZERODUR® has a coefficient of thermal expansion that is approximately zero. It is a product manufactured by Schott Glas, Geschäftsbereich Optik Optisches Glas, Hattenbergstr. 10 55122 Mainz, Germany.

Also included on pallet 52 are restraining devices 57 that prevent gross motion of plate 32 relative to pallet 52, e.g., preventing plate 32 from falling-off of pallet 52. This may result from rapid acceleration or deceleration. A system ground 59d also connects to plate 32. System ground 59d is bonded to pallet 52 and includes a clamp mechanism that provides downwardly force on surface 32a and an upwardly force on surface 32b. In this manner, bending of plate 32 due to the grounding force is avoided.

Referring again to FIG. 1, fluid control system 18 is a hydrocarbon-free system that controls pressurizing, venting and purging of system 10. To that end, fluid control system 18 includes first 64 and second 66 turbo-molecular pumps and first 68 and second 70 roughing pumps, as well as stage fluid control subsystem 71. First turbo-molecular pump 64 is in fluid communication with system airlock 60 of AMHS 16 and first roughing pump 68 is in fluid communication with first turbo-molecular pump 64, with first turbo-molecular pump 64 being connected between first roughing pump 68 and airlock 60 of AHMS 16. Second turbo-molecular pump 66 is in fluid communication with write chamber 24 and second roughing pump 70 is in fluid communication with second turbo-molecular pump 66, with second turbo-molecular pump 66 being connected between second roughing pump 70 and write chamber 24. Stage fluid control subsystem 71 is in fluid communication with stage 28, discussed more fully below.

Fluid control system 18 is designed to have uni-directional flow in all pathways to decrease the amount of particulate contamination that potentially interferes with movement of stage 28 or patterns recorded on plate 32. In this fashion, the direction of the flow through fluid control system 18 is in a common direction for both pump down and venting: top-to-bottom. In addition, mass flow controllers (not shown) may be used instead of fixed orifices at the vent locations, which decrease the time required to vent write chamber 24 or airlock 60, while minimizing turbulence in the flow.

Referring to FIGS. 3 and 6, airlock 60 includes six walls that define an airlock chamber 72. Five of the six aforementioned walls are shown as 74, 76, 78, 80 and 82. Walls 74 and 76 include a slot valve, shown as 74a and 76a, respectively. Slot valves 74a and 76a allow access to airlock chamber 72 while maintaining a fluid-tight seal. Exemplary slot valves 74a and 76a and are manufactured by and available from VAT Inc., 500 West Cummings Park, Woburn Mass. 01801. The walls of airlock 60 are thermally controlled in the range of ±0.020° C. This is achieved by the presence of fluid channels, shown in wall 78 as channels 78a through which fluids having the desired temperature are flowed. Coupled to wall 80 is a vacuum column 84, one end of which is connected to first turbo-molecular pump 64. A valve system is connected to vacuum column 84, between airlock chamber 72 and turbo-molecular pump 64. The valve system includes a gate valve 84a and an isolation valve 84b and functions to control the pressure of airlock chamber 72. Coupled to wall 82 is a rapid thermal conditioning system 90 which functions to rapidly adjust the temperature of a plate (not shown) present in the airlock 60 while avoiding adiabatic heat transfer, discussed more fully below.

Referring to FIGS. 3, 6 and 7, a cross-sectional view of airlock 60 is shown with a lift mechanism disposed within airlock chamber 72. Lift mechanism includes two spaced-apart platforms 92a and 92b and a static shield 94. The lift mechanism operates to move the plate32/pallet 52 combination, resting on platform 92a, from a position in airlock chamber 72 proximate to a slot valve (not shown) to a position proximate to rapid thermal condition system 90. Vacuum handling system 53 includes a pair of linear robots (not shown) that move plate 32/ pallet 52 combination among platforms 92a, 92b and airlock 60 and write chamber 24. The vacuum handling system 53 pushes a polished rod 53a through a pair of sliding seals 53b. The volume between these seals is pumped so that an effective seal is maintained with airlock chamber 72 with minimal forces required.

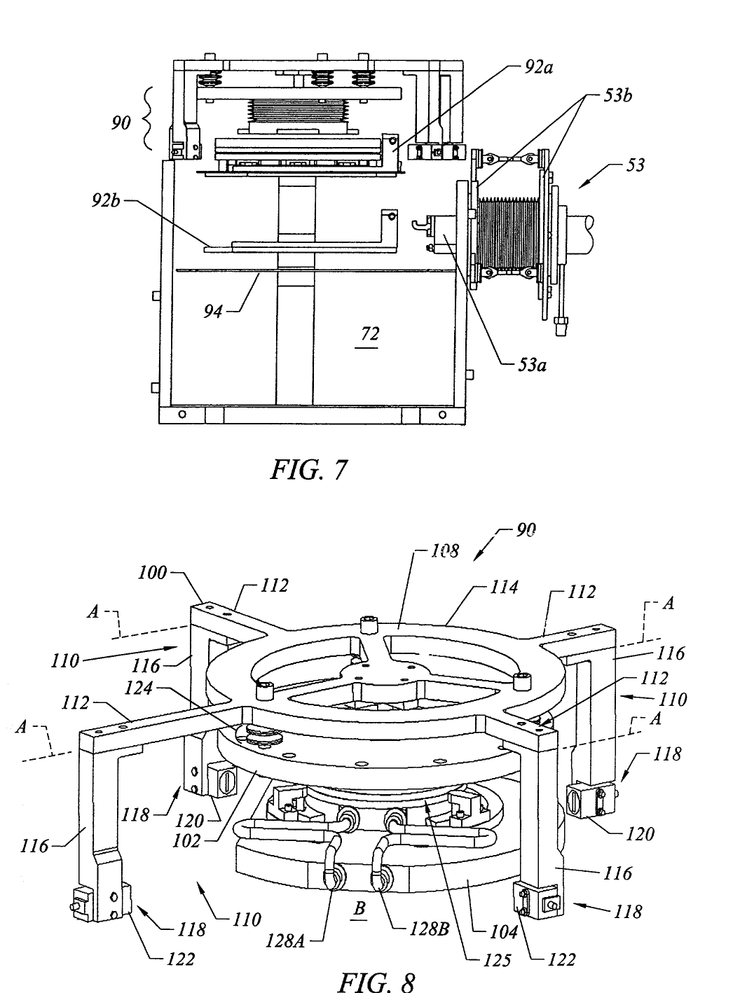

Referring to FIG. 7 and 8, rapid thermal conditioning system 90 is shown as including a frame 100 having a sealing flange 102 and a rapid thermal conditioning plate (RTCP) 104 coupled to frame 100. Frame 100 includes a rafter section 108 that lies in a plane “A”. A plurality of supports 110 is connected to rafter section 108. Each of supports 110 includes a lateral portion 112 that extends from a periphery 114 of rafter section 108, terminating in a transverse portion 116. Transverse portion 116 extends from lateral portion 112, in a direction transverse to plane “A”, terminating in a foot 118. Coupled between two feet 118 of supports 110 is a positional sensor assembly. In the present example, rapid thermal conditioning system 90 includes four supports 110, each pair of which includes a sensor assembly coupled thereto. Although any sensing device may be employed, in the present example, the sensor assembly includes an optical emitter 120 and an optical receiver 122, disposed opposite to optical emitter 120, to sense changes in optical energy emitted by optical emitter 120. Specifically, the sensor assemblies are positioned to sense the position of an object lying in plane “B”, which extends parallel to plane “A” by sensing light attenuation.

Referring to FIGS. 7 and 8, sealing flange 102 is connected between rafter section 108 and RTCP 104. Sealing flange 102 is moveably coupled to frame 100. A crash sensor assembly 124 is coupled between sealing flange 102 and rafter section 108 to sense the occurrence of impact between rafter section 108 and sealing flange 102. RTCP 104 is disposed between plane B and sealing flange 102. Sealing flange 102 fits into opening (not shown) of wall 82 to form a fluid-tight seal therewith. In this manner, RTCP 104 and crash sensor assembly 124 are disposed in airlock chamber 72. Coupled between RTCP 104 and sealing flange 102 is a bellows 125 to allow movement therebetween.

Thermal control of RTCP 104 is achieved independent of the six aforementioned airlock walls. To that end, RTCP 104 includes a plurality of fluid channels through which a supply of temperature-controlled fluids (not shown) is connected. Fluids having the desired temperature are flowed from the supply (not shown) and through the plurality of fluid channels. Fluid is introduced into fluid channels via inlet 128a and is allowed to egress therefrom through outlet 128b. The thermal energy present in the fluid is transferred to RTCP 104 to control the temperature thereof. Thermal energy is transferred between RTCP 104 and the plate (not shown) to decrease the time required to bring plate (not shown) and airlock chamber 72 to thermal equilibrium.

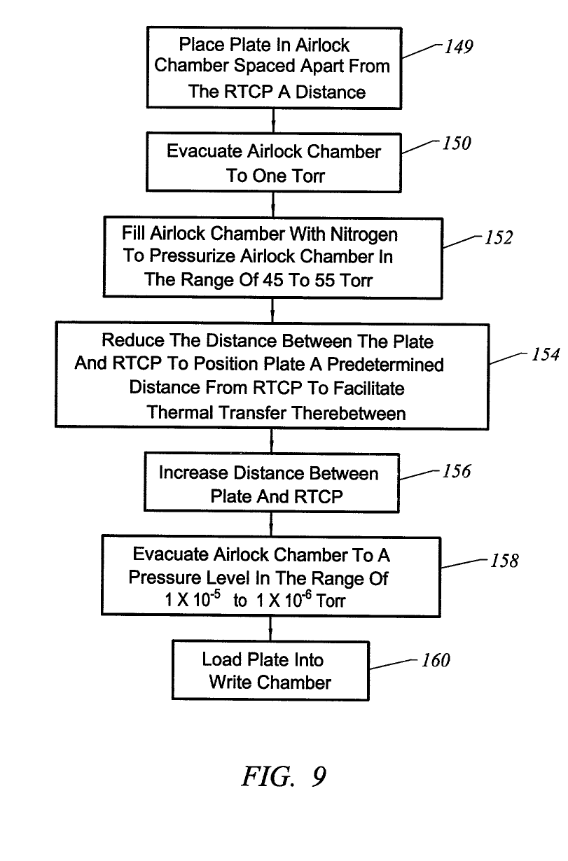

Referring to FIGS. 7, 8 and 9 in operation, the plate (not shown) is placed in airlock chamber 72 at step 149 so as to be spaced-apart from RTCP 104 a distance in excess of 0.75 inch. At step 150, airlock chamber 72 is pressurized to a level of approximately one (1) Torr. At step 152, nitrogen fills airlock chamber 72 to a pressure level in the range of 25 to 100 Torr, with 50 Torr being preferred. At step 154, lift platform 92 positions plate 32 proximate to plane B, which is in the range of 0.001″ to 0.009″ from RTCP 104 with 0.003″ being preferred. Plate 32 has a cross-sectional area that is equal to or less than a cross-sectional area of RTCP 104. In this fashion, efficient thermal transfer between RTCP 104 and plate 32 occurs primarily through conduction. It was found that gas conduction heat transfer at 50 Torr is about ten (10) times faster than radiative heat transfer. After approximately six (6) minutes, lift platform 92 increases the spacing between RTCP 104 and plate 32, at step 156. At step 158, airlock chamber 72 is evacuated to a pressure level in the range of 1×10⁻⁵ to 1×10⁻⁶ Torr. Thereafter, at step 160, plate 32 is loaded into write chamber 24, which has pressure comparable to that of airlock chamber 72, i.e., 1×10⁻⁵ to 1×10⁻⁶ Torr. Increasing the spacing between plate 32 and RTCP 104 before evacuating airlock chamber 72 to a pressure level in the range of 1×10⁻⁵ to 1×10⁻⁶ Torr minimizes thermal fluctuations resulting from adiabatic thermal transfer. Specifically, maintaining plate 32 in close proximity with RTCP 104 results in a greater amount of adiabatic heat transfer due to the Bernoulli effect. Increasing the spacing between plate 32 and RTCP 104 before evacuating chamber 72 reduces the Bernoulli effect and, therefore adiabatic heat transfer. This facilitates maintaining equilibrium of plate 32 with airlock chamber 72 ambient and therefore reduces the ambient in write chamber 24. In this manner, thermal equilibrium may be achieved within 0.001° C., which avoids thermal fluctuations and, therefore problematic dimensional changes in plate 32. As a result, a pattern may be precisely located on plate 32. Alternatively, or in conjunction with, the method discussed above, the thermal equilibrium may be reached by having a priori knowledge of the thermal variations due to adiabatic thermal transfer with plate 32 positioned at differing distances from RTCP 104, or in the absence of RTCP 104 altogether. Then, plate 32 would be heated appropriately in garages 50, usually in excess of the temperature of the ambient in write chamber 24. In this manner, thermal equilibrium between plate 32 and the ambient in write chamber 24 may be achieved.

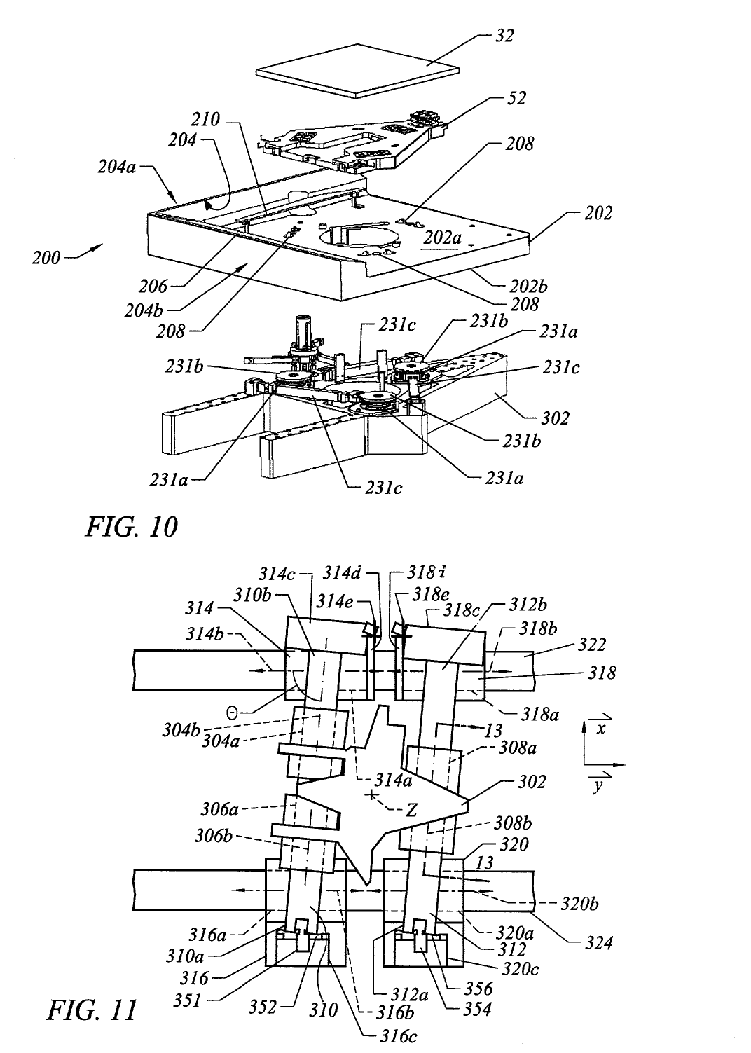

Referring to FIGS. 2 and 10, once loaded into write chamber 24, plate 32/pallet 52 combination rests atop of worktable 200 that functions to support plate 32 and provide a reference for measuring plate position, including height of the same with respect to the focus of the e-beam (not shown). Worktable 200 includes a stage mirror 202. Any type of optical reflecting device may be employed, and in the present example stage mirror 202 is a monolithic optical component from a ceramic compound. Although any ceramic material may be employed, stage mirror 202 is formed from a ceramic material having a very low coefficient of thermal expansion, such as ZERODUR®. Stage mirror 202 has a rectangular shape with dimensions of approximately 15.75″×15.25″ and 2.0″ thick and includes two opposed major surfaces 202a and 202b. Extending from a first edge of surface 202a, and away from surface 202b, is a first vertical projection 204 defining a surface 204a. Extending from a second edge of surface 202a, and away from surface 202b, is a second vertical projection 206, defining a surface 206a. The material from which stage mirror 202 is manufactured facilitates providing a highly polished texture to surfaces 204a and 206a.

Included on surface 202a is a plurality of bipods 208. Bipods 208 are kinematic mounting hardware devices that properly position pallet 52 on stage mirror 202. Specifically, bipods 208 facilitate positioning of each pallet 52 upon stage mirror 202 within 10 nm of the position of pallet 52 previously resting upon stage mirror 202. Bipods 208 are designed to provide a joint exhibiting high lateral and vertical stiffness between pallet 52 and stage mirror 208. Stage mirror may also include restraining devices, one of which is shown as a clamping assembly 210 that prevents motion of pallet 52 relative to stage mirror 202 in the event of gross changes in acceleration, e.g., deceleration on the order of 3g.

Stage mirror 202 is mounted to stage 28 via a stage plate 302. Specifically, stage mirror 202 is coupled to stage plate 302 through vertical actuators 231a, which are available from New Focus nc. Vertical actuators 231a are housed by an isolation mount 231b that contains particulate contamination vertical actuators 231a may produce. Three tangential fixtures 231c are also coupled between stage mirror 202 and stage plate 302. Tangential fixtures 231c reduce, if not prevent, stage mirror 202 from moving laterally or in yaw relative to stage plate 302, while allowing vertical freedom. To that end, one end of each of tangential fixtures 231c is connected to stage plate 302, with the remaining end being connected to a vertical actuator 231a.

Referring to FIGS. 10 and 11, stage mirror 208 is attached to one side of stage plate 302, and three chamber assemblies 304, 306 and 308 are attached to a side of stage plate 302, disposed opposite to stage mirror 208. Each of chamber assemblies 304, 306 and 308 defines a bearing chamber, 304a, 306a and 308a, respectively. Bearing chamber 304a is spaced apart from bearing chamber 306a, with a longitudinal axis 304b of bearing chamber 304a being collinear with a longitudinal axis 306b of bearing chamber 306a. Bearing chamber 308a is spaced apart from bearing chambers 304a and 306a, with a longitudinal axis 308b of bearing chamber 308a being spaced apart from axes 304b and 306b and extending parallel thereto and nominally lying in a common plane. Extending through bearing chambers 304a and 306a is a journal 310, and a journal 312 extends through bearing chamber 308a.

A first pair of spaced-apart bearing housings 314 and 316 is coupled to opposing ends of journal 310, and a second pair of spaced-apart bearing housings 318 and 320 is coupled to opposing ends of journal 312. Each of bearing housings 314, 316, 318 and 320 defines a bearing chamber, 314a, 316a, 318a and 320a, respectively. Bearing chamber 314a is spaced apart from bearing chamber 316a, with a longitudinal axis 314b of bearing chamber 314a being collinear with a longitudinal axis 316b of bearing chamber 316a. Bearing chamber 318a is spaced apart from bearing chamber 320a, with a longitudinal axis 318b of bearing chamber 318a being collinear with a longitudinal axis 320b of bearing chamber 320a. Axes 314b and 316b extend parallel to axes 318b and 320b and are spaced-apart therefrom. Axes 314b, 316b, 318b and 320b lie in a common plane that extends parallel to the plane in which axes 304b, 306b and 308b lie, but is spaced-apart therefrom. Extending through bearing chambers 314a and 318a is a journal 322, and a journal 324 extends through bearing chambers 316a and 320a.

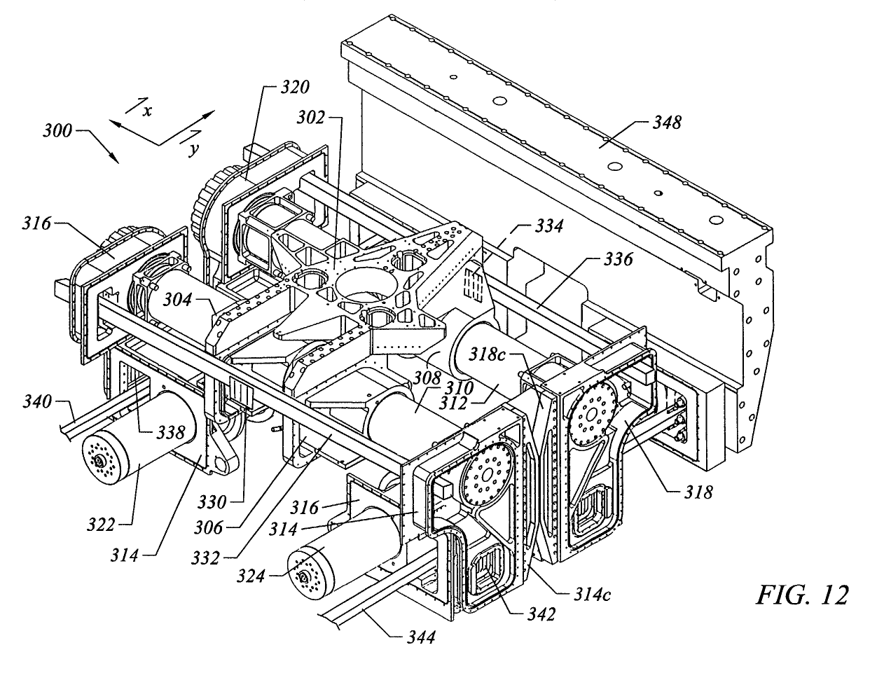

Referring to both FIGS. 11 and 12, journals 310 and 312 facilitate movement of stage plate 302 along a first direction, referred to as the X direction. Journals 322 and 324 facilitate movement of stage plate 302 along a second direction that is transverse to the first direction and referred to as the Y direction. To that end, four linear motors are employed. A first linear motor includes a coil 330 and stator 332. Coil 330 is coupled to chamber assembly 304 and is in electromagnetic communication with stator 332. Stator 332 is connected between bearing housings 314 and 316 to extend parallel to the X direction. A second linear motor includes a coil 334 and stator 336. Coil 334 is coupled to chamber assembly 308 and is in electromagnetic communication with stator 336. Stator 336 is connected between bearing housings 318 and 320 to extend parallel to the X direction. Although not shown, stators 332 and 336 extend between, and are coupled to, opposing walls of write chamber 24.

A third linear motor includes a coil 338 and stator 340. Coil 338 is coupled to bearing housing 314 and is in electromagnetic communication with stator 340. Stator 340 extends parallel to the Y direction. A fourth linear motor includes a coil 342 and stator 344. Coil 342 is coupled to bearing housing 316 and is in electromagnetic communication with stator 344. Stator 344 extends parallel to the Y direction. Stators 340 and 344 extend between opposing grounding bodies 348 and 350. In addition, journals 322 and 324 extend between, and are coupled to, grounding bodies 348 and 350. To reduce the friction to which journals 310, 312, 322, 324 are exposed, an fluid-bearing system is employed.

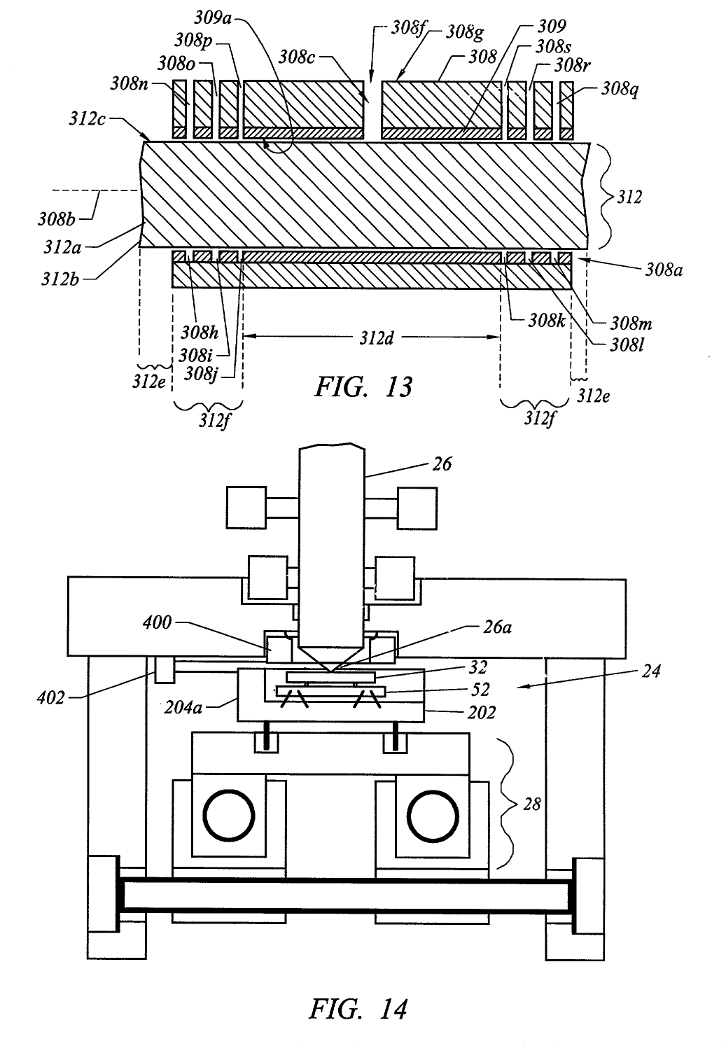

Referring to FIG. 13, the fluid-bearing system is discussed with respect to journal 312 and chamber assembly 308 for simplicity. Bearing chamber 308a is clad with a bronze sleeve 309 and journal 312 is formed from silicon carbide. Sleeve 309 defines an outer surface 309a of sleeve 309. Formed into chamber assembly 308 is a fluid inlet 308c. Fluid inlet 308c extends from an exterior surface 309a of chamber assembly 308 and terminates in an aperture 308f formed in an exterior surface 308g of chamber assembly 308. Two sets of annular grooves flank fluid inlet 308c. One set of the annular grooves is shown as grooves 308h, 308i and 308j, with the remaining set of annular grooves shown as grooves 308k, 308l and 308m. In fluid communication with each of annular grooves is an exhaust passage. Specifically, exhaust passage 308n is in fluid communication with annular groove 308h. Exhaust passage 308o is in fluid communication with annular groove 308i. Exhaust passage 308p is in fluid communication with annular groove 308j. Exhaust passage 308q is in fluid communication with annular groove 308k. Exhaust passage 308r is in fluid communication with annular groove 308l, and exhaust passage 308s is in fluid communication with annular groove 308m.

Referring to FIGS. 1 and 13, fluid, such as air, is injected into air inlet 308c by stage fluid control subsystem 71 to provide a cushion, referred to as an fluid-bearing, between exterior surface 312c and exterior surface 309a. In this manner, mechanical disturbance due, in part, to imperfections in the machining of the various parts of stage 28 may be avoided. To that end, fluid is introduced into air inlet 308c. The fluid exiting air inlet 308c bifurcates into two substantially symmetrical flows. One of the flows is evacuated through annular grooves 308h, 308i and 308j. The remaining flow is evacuated through annular grooves 308k, 308l and 308m. Annular grooves 308h, 308i, 308j, 308k, 308l and 308m are in fluid communication with stage fluid control subsystem 71. The pressure associated with fluid entering air inlet 308c is greater than the pressure associated with annular grooves 308h, 308i, 308j, 308k, 308l and 308m. Air entering air inlet 308c travels toward annular grooves 308h, 308i, 308j, 308k, 308l and 308m between exterior surface 312c and exterior surface 309a. Fluid entering annular grooves 308j and 308k is vented to atmosphere through exhaust passages 308p and 308s, respectively. Fluid traveling into annular grooves 308i and 308l is evacuated under vacuum of approximately 10 Torr by a vacuum system (not shown) in fluid communication therewith via exhaust passageways 308o and 308r, respectively. Fluid traveling into annular grooves 308h and 308m is evacuated under vacuum of approximately 0.1 Torr by a vacuum system (not shown) in fluid communication therewith via exhaust passageways 308n and 308q, respectively. In this manner, independent evacuation pressures are provided among annular grooves 308h, 308i, 308j, 308k, 308l and 308m.

The presence of annular grooves 308h, 308i, 308l and 308m and the evacuation pressure associated therewith facilitates creation of the fluid-bearing exterior surface 312c and exterior 309a in the face of the high-vacuum environment of write chamber 24. Specifically, the presence of the aforementioned grooves creates a differential pumping effect over region 312d of surface 312c. This differential pumping effect also maintains a pressure gradient between region 312d and a region 312e of surface 312c not exposed to the aforementioned flows of fluid, which is substantially independent of the movement between journal 312 and chamber assembly 308. The pressure gradient substantially reduces fluid flowing beyond region 312d. Fluid passing from region 312d to region 312e is less than 1×10⁻³ Torr-Liter/second. In this manner, a fluidbearing is maintained in region 312d that operates as a lubricant, while maintaining a distance between exterior surface 312c and exterior 309a to be approximately five (5) microns. The position of the fluid-bearing moves with respect to journal 312 and maintains a fixed spatial relationship with respect to chamber assembly 308, substantially defined between annular grooves 308j and 308k.

The presence of annular grooves 308h, 308i, 308l and 308m also introduces additional length of surface 309a which extends beyond region 312d in which the fluid-bearing is substantially defined. Each of grooves 308h, 308i, 308j, 308k, 308l and 308m is approximately ⅛″ wide, measured in a direction parallel to longitudinal axis 308b. The spacing between adjacent grooves 308h, 308i, 308j, 308k, 308l and 308m is ⅜″, with the spacing between an end of chamber 308a and one of grooves 308h and 308m being ⅜″. As a result, regions 312f, which are disposed between regions 312d and 312e, include approximately 1 ⅛″ of surface 312c across which a fluid-bearing is not well defined. This increases the probability of friction between surface 309a and regions 312f due to mechanical and thermal fluctuations. However, the aforementioned friction is avoided by ensuring that the fluid pressure between region 312d and surface 309a is in the range of 95 pounds/inch² to 120 pound/inch², inclusive. To that end, control processor 40 includes a set of instructions to control fluid control system 18 to maintain a cushion of fluid between surface 309a and surface 312c.

Although the foregoing discussion concerns journal 312 and chamber assembly 308, it should be understood that this discussion applies equally to the fluid-bearing formed with respect to journal 310 and chamber assemblies 304 and 306, and the fluid-bearing formed with respect to journal 322 and bearing housings 314 and 318, as well as the fluid-bearing formed between journal 324 and bearing housings 316 and 320.

Referring again to FIG. 11, stage 28 is configured to provide motion about an axis, Z, that extends transversely to both the X and Y directions. To that end, a pivot assembly is coupled to journals 310 and 312. One pivot assembly is coupled between end 310a of journal 310 and a pivot support 316c of bearing housing 316 and includes a flexible cog 351 and a flexible membrane 352. Cog 351 extends between end 310a and pivot support 316c, with flexible member 352 extending between cog 351 and pivot support 316c. An additional pivot assembly coupled between end 312a of journal 312 and a pivot support 320c of bearing housing 316 and includes a cog 354 and a flexible membrane 356. Cog 354 extends between end 312a and pivot support 320c, with flexible membrane 356 extending between cog 354 and pivot support 320c. Cogs 351 and 354 and flexible membranes 352 and 356 are formed from a pliable and strong metallic material, such as titanium. Forming cogs 351 and 354 and flexible membrane 352 and 356 from a metallic material provides flexibility without generating particulate contamination associated with other flexible materials, such as polymer and rubber materials. In addition, titanium provides cogs 351 and 354 and flexible membranes 352 and 356 with extended operational life.

Another pivot assembly is coupled between ends 310b of journal 310 and a pivot support 314c of bearing housing 314. End 310b is fixedly attached to pivot support 314c, and pivot support 314c is coupled to bearing housing 314 via a flexible member 314d to rotate about axis 314e. Axis 314e extends parallel to axis Z. Another pivot assembly is coupled between end 312b of journal 312 and a pivot support 318c of bearing housing 318. End 312b is fixedly attached to pivot support 318c, and pivot support 318c is coupled to bearing housing 318 via a flexible member 318d to rotate about axis 318e. Axis 318e extends parallel to axis Z. With this configuration, axes 304a, 306a and 308a may form oblique angles θ with respect to axes 314b, 316b, 318b and 320b. Pivot supports 314c and 316c are formed from the same materials discussed above with respect to cogs 351 and 354. In addition, the aforementioned pivot assemblies facilitate expansion motion of journals 310 and 312, along a direction parallel to the X direction. To that end, the ends of journals 322 and 324 are connected to grounding bodies (not shown) employing the cog and flexible membrane configuration (not shown) mentioned above with respect to journal ends 310a and 312a.

Referring to FIG. 14, once plate 32 and pallet 52 are positioned in write chamber 24, plate 32 is positioned in a write plane 24a by moving stage mirror 202. To that end, stage mirror 202 is coupled to stage plate 230 through vertical actuators 231. Vertical actuators 231 may adjust the position of stage mirror 202 in nanometer increments. Vertical plate 32 position is determined via feedback provided by a sensing system 400 concentric about e-beam source 26. Horizontal plate position is determined by a pair of interferometers detecting light reflecting from mirror 202, one of which is shown as interferometer 402 reflecting from surface 204a. After plate 32 is positioned properly, e-beam source 26 produces an e-beam 26a that impinges upon plate 32. Stage 28 moves the plate 32 accordingly to allow e-beam 26a to be exposed to the appropriate regions of plate 32 and record the desired pattern thereon.

The foregoing describes an exemplary embodiment of the invention and it is understood that various modifications may be made to the invention as described above while staying within the scope thereof. Therefore, the scope of the invention should not be based upon the foregoing description. Rather, the scope of the invention should be determined based upon the claims recited herein, including the full scope of equivalents thereof.

What is claimed is:

1. A stage system comprising:
a journal having a longitudinal axis;
a body defining a chamber having a chamber wall, with said journal passing through said chamber, said body having a fluid inlet and a plurality of fluid outlets flanking said fluid inlet, with said fluid inlet and said plurality of fluid outlets being in fluid communication with said chamber; and
a fluid supply system to introduce a supply fluid into said chamber through said fluid inlet and evacuate said supply fluid through said plurality of outlets so as to maintain a cushion of fluid between said chamber wall and said journal.

2. The stage system as recited in claim 1 wherein said chamber wall surrounds a sub-portion of said journal, defining a housed portion, with the remaining portion of said journal defining an exposed portion, with said fluid supply system introducing said supply fluid into said chamber through said fluid inlet and evacuating said supply fluid through said plurality of outlets to creating a pressure differential over a length of said housed portion.

3. The stage system as recited in claim 1 wherein said chamber walls surround a sub-portion of said journal, defining a housed portion, with the remaining portions defining an exposed portion, with said fluid supply system introducing said supply fluid into said chamber through said fluid inlet and evacuating said supply fluid through said plurality of outlets to reduce said supply fluid from egressing from said housed portion to said exposed portion.

4. The stage system as recited in claim 1 further including an additional body defining an additional chamber having a chamber surface and an additional journal having an additional longitudinal axis associated therewith, with said additional longitudinal axis extending transversely to said longitudinal axis, with said additional journal passing through said additional chamber, said body having fluid entry way and a plurality of fluid exhausts flanking said fluid entry way inlet, with said fluid entry way and said plurality of fluid outlets being in fluid communication with said additional chamber, with said fluid supply system to introduce said supply fluid into said additional chamber through said fluid entry way and evacuate said supply fluid through said plurality of exhausts so as to maintain a cushion of fluid between said chamber surface and said additional journal.

5. A stage system comprising:
a plurality of spaced-apart journals arranged in first and second pairs, with each of said plurality of journals having a longitudinal axis, and;
a plurality of chamber assemblies, each of which defines a chamber having a chamber wall surrounding a sub-portion of one of said plurality of journals and having a fluid inlet and a plurality of fluid outlets flanking said fluid inlet, with said fluid inlet and said plurality of fluid outlets being in fluid communication with said chamber; and
a fluid supply system to introduce a supply fluid into said chamber through said fluid inlet and evacuate said supply fluid through said plurality of outlets so as to maintain a cushion of fluid between said chamber wall and said journal.

6. The stage system as recited in claim 5 wherein said sub-portion defines a housed portion, with the remaining portions of said one of said plurality of journals defining an exposed portion, with said fluid supply system introducing said supply fluid into said chamber through said fluid inlet and evacuating said supply fluid through said plurality of outlets to create a pressure differential over a length of said housed portion.

7. The stage system as recited in claim 5 wherein sub-portion defines a housed portion, with the remaining portions of said one of said plurality of journals defining an exposed portion, with said fluid supply system introducing said supply fluid into said chamber through said fluid inlet and evacuating said supply fluid through said plurality of outlets to create a pressure differential between said housed portion and said exposed portion.

8. The stage system as recited in claim 5 further including a pivot assembly coupled between each of the journals associated with said first pair and one of said plurality of chamber assemblies, with said pivot assembly including a pivot support, a flexible cog extending between said pivot support and said journal and a flexible membrane, with said flexible membrane extending between said cog and said pivot support to allow said first pair of journals to pivot.

9. The stage system as recited in claim 5 further including a pivot assembly coupled between each of the journals associated with said first pair and one of said plurality of chamber assemblies, with said pivot assembly including a pivot support and a flexible member connected between said pivot support and said one of said plurality of chamber assemblies to allow said movement of said first pair of journal about an axis extending transversely to the longitudinal axes of each of said plurality of journals.

10. The stage system as recited in claim 5 further including opposed grounding bodies, each of which is coupled to one end of each of the journals associated with said second pair by a pivot assembly, with said pivot assembly including a pivot support connected to one of said opposed grounding bodies, a flexible cog extending between said pivot support and said journal and a flexible membrane, with said flexible membrane extending between said cog and said pivot support to allow said second pair of journals to pivot.

11. A method operating a stage system to reduce friction between a journal and a wall of chamber surrounding said journal, said method comprising:
introducing an input flow of fluid into said chamber at a region;
creating a plurality of exhaust flows to remove said fluid from said chamber flanking said region; and
establishing said input flow and said plurality of exhaust flows to maintain a cushion of fluid between said chamber wall and said journal.

12. The method as recited in claim 11 wherein creating a plurality of exhaust flows further includes arranging said plurality of exhaust flows in two sets of exhaust flows, with each set of exhaust flows being spaced apart from said input flow and including multiple exhaust flows, creating an evacuation pressure with each of the multiple exhaust flows so that said evacuation pressure associated with one of said multiple exhausts of one of said two sets, differs from the evacuation pressure associated with the remaining multiple exhaust flows of said one of said two sets.

13. The method as recited in claim 11 wherein said chamber wall surrounds a sub-portion of said journal, defining a housed portion, with the remaining portions of said journal defining an exposed portion, with establishing said input flow and said plurality of exhaust flows to maintain a cushion of fluid between said chamber wall and said journal while reducing leakage of fluid from said housed portion to said exposed portion.

14. The method as recited in claim 11 further including translating said chamber over a length of said journal while maintaining said cushion of fluid.

15. The method as recited in claim 12 wherein establishing said input flow and said plurality of exhaust flows to maintain a cushion of fluid between said chamber wall and said journal further includes providing fluid in said region with a pressure in the range of 95 pounds per/inch² to 120 pounds per/inch², inclusive.

16. The method as recited in claim 11 further including providing an additional journal and an additional chamber having a chamber surface, with said additional journal extending through said additional chamber and being coupled to said journal, said journal and said additional journal defining first and second longitudinal axes, respectively, with said first longitudinal axis extending transversely to said second longitudinal axis and defining an angle therebetween and varying a magnitude associated with said angle.

17. The method as recited in 15 wherein introducing an input flow further includes introducing an additional input flow of said fluid into said additional chamber and creating a plurality of exhaust flows further includes creating a plurality of additional exhaust flows, flanking said input flow, to remove said fluid from said additional chamber.

18. A stage system comprising:
a plurality of spaced-apart journals arranged in first and second pairs, with each of said plurality of journals having a longitudinal axis, and;
a plurality of chamber assemblies, each of which defines a chamber having a chamber wall surrounding a sub-portion of one of said plurality of journals and having a fluid inlet and a plurality of fluid outlets flanking said fluid inlet, with said fluid inlet and said plurality of fluid outlets being in fluid communication with said chamber;
a fluid supply system to introduce a supply fluid into said chamber through said fluid inlet and evacuate said supply fluid through said plurality of outlets; and
a process control system in data communication with said fluid supply system, said process control system including a memory having embodied therein a program including a set of instructions to control said fluid supply system to establish a pressure within said chamber at a predetermined level so as to maintain a cushion of fluid between said chamber wall and said journal.

19. The system as recited in claim 18 wherein said first set of instructions further includes a subroutine to control said fluid supply system to provide fluid in said region with a pressure in the range of 95 pounds per/inch² to 120 pounds per/inch², inclusive.

20. The system as recited in claim 18 wherein a portion of said one of said plurality of journals being surrounded by said chamber defining a housed portion, with the remaining portion of said one of said plurality of journals defining an exposed portion, with said set of instructions further including a subroutine establishing said input flow and said plurality of exhaust flows to maintain a cushion of fluid between said chamber wall and said journal while reducing leakage of fluid from said housed portion to said exposed portion.
